(19) United States
(12) Patent Application Publication
(10) Pub. No.: US 2024/0397001 A1
(43) Pub. Date: Nov. 28, 2024

(54) INSPECTION APPARATUS, INSPECTION SYSTEM AND CONTROL METHOD FOR INSPECTION APPARATUS

(71) Applicant: CANON KABUSHIKI KAISHA, Tokyo (JP)

(72) Inventor: YOSHITAKA OBA, Chiba (JP)

(21) Appl. No.: 18/671,302

(22) Filed: May 22, 2024

(30) Foreign Application Priority Data
May 26, 2023 (JP) 2023-086633

(51) Int. Cl. H04N 1/00

(52) U.S. Cl. CPC H04N 1/00015; H04N 1/00005; H04N 1/00087; H04N 1/0009; H04N 1/00411

(57) ABSTRACT

An inspection apparatus includes an inspection unit configured to, based on a read image acquired by reading, with a reading unit, each of printed products which are sequentially conveyed and a preliminarily registered reference image, inspect each of the printed products, a setting unit configured to set an inspection region targeted for an inspection to be performed, and a storage unit configured to store information about the inspection region for a first image which is repeatedly used, wherein the inspection unit inspects a printed product in which a third image obtained by combining the first image and a second image with each other has been printed, based on the inspection region set by the setting unit and the inspection region for the first image the information about which has been stored in the storage unit.

### BACKGROUND

### Field of the Disclosure

Aspects of the present disclosure generally relate to an inspection apparatus, an inspection system, and a control method for an inspection apparatus.

### Description of the Related Art

Recently, there has been known an inspection system in which an inspection apparatus inspects a sheet (printed product) on which printing has been performed by a printing apparatus during the process of the sheet being conveyed. In inspecting a printed product, the inspection apparatus reads an image of the printed sheet, which is being conveyed, and performs image analysis on the read image, thus determining whether the printed product is normal. The inspection apparatus is capable of detecting, for example, broken character string or rule, missing image, defective printing, and missing page.

Moreover, variable printing, in which a document, such as a bill or a billing statement, is combined with various advertising images, has been in widespread use. Variable printing is configured with form image data (master data), which is data in common between printed products, and variable data, which is variable depending on printed products, such as names of customers. Since variable printing varies in output configurations by users, it is necessary to inspect whether a printed product has been made to have a proper configuration. Japanese Patent Application Laid-Open No. 2012-000876 discusses a technique which designates a variable data portion and master data portion and then inspects each of the designated variable data portion and master data portion.

### SUMMARY

According to embodiments of the present disclosure, an inspection apparatus includes a reception unit configured to receive a read image acquired by reading, with a reading unit, each of printed products which are sequentially conveyed and received from an image forming unit, an inspection unit configured to inspect each of the printed products based on the read image and a preliminarily registered reference image, a setting unit configured to set an inspection region targeted for an inspection to be performed by the inspection unit, and a storage unit configured to store information about the inspection region for a first image which is repeatedly used, wherein the inspection unit inspects a printed product in which a third image obtained by combining the first image and a second image with each other has been printed, based on the inspection region set by the setting unit and the inspection region for the first image the information about which has been stored in the storage unit.

Further features of the present disclosure will become apparent from the following description of exemplary embodiments with reference to the attached drawings.

### BRIEF DESCRIPTION OF THE DRAWINGS

FIG. 1 a schematic diagram illustrating a configuration of an inspection system in a first exemplary embodiment.

FIG. 2 is a block diagram illustrating a configuration of the inspection system in the first exemplary embodiment.

FIG. 3 is a diagram illustrating an internal configuration of the inspection system in the first exemplary embodiment.

FIG. 4 is a diagram illustrating an example of a setting screen for a print job which is processed by an information processing apparatus.

FIGS. 5A, 5B, and 5C are diagrams illustrating a reference image and content region information which are used by a printing apparatus and an inspection apparatus in the first exemplary embodiment.

FIGS. 6A, 6B, and 6C are diagrams illustrating content region information for image composition data obtained by combining content region information for master data and content region information for variable data in the first exemplary embodiment.

FIG. 7 is a diagram illustrating inspection region setting in master data in the first exemplary embodiment.

FIG. 8 is a flowchart illustrating preprocessing which the information processing apparatus performs when performing image composition for a print job in the first exemplary embodiment.

FIG. 9 is a flowchart illustrating processing for retaining a print job in a storage unit of the information processing apparatus in the first exemplary embodiment.

FIG. 10 is a flowchart illustrating processing for combining a print job retained in the storage unit of the information processing apparatus and a print job input from a client computer in the first exemplary embodiment.

FIG. 11 is a flowchart illustrating preprocessing which the inspection apparatus performs when inspecting image composition data obtained by image composition in the first exemplary embodiment.

FIG. 12 is a flowchart illustrating preprocessing which the inspection apparatus performs when retaining inspection region setting for image composition data in the storage unit of the inspection apparatus in the first exemplary embodiment.

FIG. 13 is a flowchart illustrating processing which the inspection apparatus performs to inspect image composition data obtained by the information processing apparatus performing image composition in the first exemplary embodiment.

FIG. 14 is a diagram illustrating a setting screen for inspection region setting which is displayed on the inspection apparatus of the inspection system in the first exemplary embodiment.

FIG. 15 is a diagram illustrating a screen for an inspection status which is displayed by the inspection apparatus in the first exemplary embodiment.

FIG. 16 is a flowchart illustrating processing which the inspection apparatus performs to inspect image composition data obtained by combining master data for which there is no inspection setting and which is retained in the information processing apparatus and variable data which has been input from the client computer in a second exemplary embodiment.

FIG. 17 is a flowchart illustrating processing for inspecting image composition data obtained by image-combining master data for which content region information is not yet registered and variable data which has been input from the client computer in a third exemplary embodiment.

FIG. 18 is a diagram illustrating master data registration processing which the information processing apparatus and the inspection apparatus perform in the first exemplary embodiment.

FIG. 19 is a diagram illustrating composition processing for master data and variable data which the information processing apparatus and the inspection apparatus perform in the first exemplary embodiment.

### DESCRIPTION OF THE EMBODIMENTS

Various exemplary embodiments, features, and aspects of the disclosure will be described in detail below with reference to the drawings. Furthermore, the following exemplary embodiments are not intended to limit the disclosure, and, moreover, not all of the combinations of features described in the exemplary embodiments are essential for solutions in the disclosure.

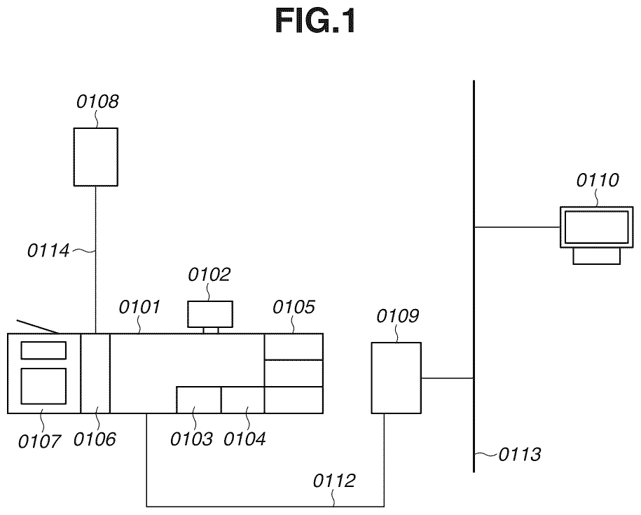

FIG. 1 is a schematic diagram illustrating an inspection system according to a first exemplary embodiment of the present disclosure. The inspection system in the first exemplary embodiment is configured with at least an information processing apparatus 0109, an inspection apparatus 0108, and a printing apparatus 0101. Furthermore, while the printing apparatus in the first exemplary embodiment is described with use of an electrophotographic type printing apparatus, the printing apparatus in the first exemplary embodiment can be a printing apparatus of a different image forming type, such as an inkjet type or an offset type.

The printing apparatus 0101 is connected to the information processing apparatus 0109 via a cable 0112. The information processing apparatus 0109 is connected to a client computer 0110 via a network 0113. The printing apparatus 0101 includes a user interface (UI) panel 0102, a paper feed deck 0103, and a paper feed deck 0104. Additionally, an option deck 0105, which includes three-stage paper feed decks, is connected to the printing apparatus 0101. The printing apparatus 0101 is, for example, an electrophotographic type printing apparatus. Moreover, the UI panel 0102 is a user interface equipped with, for example, a capacitive type touch panel.

Additionally, the printing apparatus 0101 includes an inspection unit 0106 and a large-capacity stacker 0107. The inspection unit 0106 is connected to the inspection apparatus 0108 via a cable 0114. The large-capacity stacker 0107 includes a main tray and a top tray, and the main tray allows several thousands of sheets of paper to be stacked thereon at a time.

A print job is generated by the client computer 0110, is transmitted to the information processing apparatus 0109 via the network 0113, and is then managed by the information processing apparatus 0109. Then, the print job is transmitted from the information processing apparatus 0109 to the printing apparatus 0101 via the cable 0112, so that the printing apparatus 0101 performs print processing for printing on a sheet of paper. Furthermore, a configuration in which a print job is generated and managed by the information processing apparatus 0109, is transmitted to the printing apparatus 0101 via the cable 0112, and is then managed by the printing apparatus 0101 can be employed.

Furthermore, a configuration in which the client computer 0110, the information processing apparatus 0109, and the inspection apparatus 0108 are connected to the cable 0112 and are thus able to communicate with the printing apparatus 0101 can be employed. Moreover, a configuration in which the inspection apparatus 0108 is also connected to the information processing apparatus 0109 and the client computer 0110 via the network 0113 can be employed. Thus, the connection configuration of the printing apparatus 0101, the information processing apparatus 0109, and the client computer 0110 illustrated in first exemplary embodiment is merely an example, and, naturally, there are various connection configurations in addition to that illustrated in the first exemplary embodiment.

Moreover, a configuration in which, in addition to the inspection unit 0106 and the large-capacity stacker 0107, for example, a finisher capable of performing stapling, a folding machine, or a bookbinding machine is connected to the printing apparatus 0101 can also be employed.

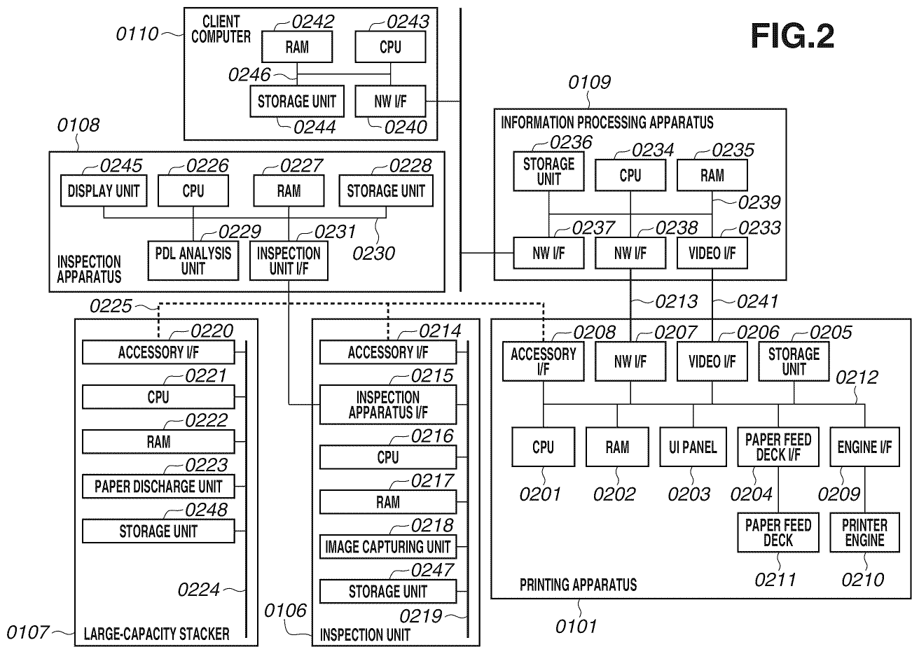

FIG. 2 is a block diagram illustrating a control configuration of the printing apparatus 0101, the inspection apparatus 0108, the large-capacity stacker 0107, the information processing apparatus 0109, and the client computer 0110 according to the first exemplary embodiment.

A central processing unit (CPU) 0201 performs control and computation operations on respective units included in the printing apparatus 0101 via a system bus 0212. The CPU 0201 performs execution of a program which is stored in a storage unit 0205 and is then loaded onto a random access memory (RAM) 0202. The RAM 0202 is a type of general volatile storage device which the CPU 0201 is able to directly access, and is used as a work area for the CPU 0201 or an additional temporary data storage region. The storage unit 0205 functions as a temporary storage region and a work memory during an operation of the printing apparatus 0101.

An engine interface (I/F) 0209 performs communication with and control on a printer engine 0210. A paper feed deck I/F 0204 performs communication with and control on a paper feed deck 0211. The paper feed deck 0211 collectively means, as a hardware configuration, the paper feed decks 0103 and 0104 and the option deck 0105. A UI panel 0203 is a hardware configuration of the UI panel 0102, and is a user interface which is used to perform general operations on the printing apparatus 0101. In the first exemplary embodiment, it is assumed that the UI panel 0203 is equipped with a capacitive type touch panel.

A network interface (hereinafter referred to as “NW I/F”) 0207 is connected to an NW I/F 0238 of the information processing apparatus 0109 via a cable 0213, and is able to communicate with the information processing apparatus 0109 and the printing apparatus 0101. Furthermore, while, in this example, a form in which the interfaces connected to system buses 0212 and 0239 are directly connected to each other is employed, a form in which the information processing apparatus 0109 and the printing apparatus 0101 are connected to each other via, for example, a network can be employed, so that the connection form is not limited. A video I/F 0206 is connected to a video I/F 0233 via a video cable 0241, and performs communications of image data between the information processing apparatus 0109 and the printing apparatus 0101.

Furthermore, the connection interface with the printing apparatus 0101 included in the information processing apparatus 0109 can be configured as a form obtained by integrating the functions of the NW I/F 0238 and the video I/F 0233. Moreover, the connection interface with the information processing apparatus 0109 included in the printing apparatus 0101 can be configured as a form obtained by integrating the functions of the NW I/F 0207 and the video I/F 0206.

An accessory I/F 0208 is connected to an accessory I/F 0214 and an accessory I/F 0220 via a cable 0225. Thus, the printing apparatus 0101 performs mutual communications with the inspection unit 0106 and the large-capacity stacker 0107 via the accessory I/Fs 0208, 0214, and 0220.

A CPU 0216 performs control and computation operations on respective units included in the inspection unit 0106 via a system bus 0219, and performs execution of a program which is stored in a storage unit 0247 and is then loaded onto a RAM 0217. The RAM 0217 is a type of general volatile storage device which the CPU 0216 is able to directly access, and is used as a work area for the CPU 0216 or an additional temporary data storage region. The storage unit 0247 functions as a temporary storage region and a work memory during an operation of the inspection apparatus 0108. An inspection apparatus I/F 0215 is connected to an inspection unit I/F 0231 via a cable. Thus, the inspection unit 0106 performs communication with the inspection apparatus 0108 via the inspection apparatus I/F 0215 and the inspection unit I/F 0231.

An image capturing unit 0218, which includes an image capturing function equipped with, for example, a contact image sensor (CIS), captures an image of a sheet of paper passing through the inside of the inspection unit 0106 and then transmits the captured image to the inspection apparatus 0108 via the inspection apparatus I/F 0215. Furthermore, the CIS mounted in the image capturing unit 0218 is an example of a sensor and can be replaced by another type of sensor, such as a charge-coupled device (CCD) image sensor, so that the image capturing method is not limited. There are two purposes for transmitting the captured image. One purpose is to, regardless of methods for inspection, capture an image of a printed product in a print job targeted for inspection and transmits the captured image to the inspection apparatus 0108 for inspection. The other purpose is to, in a case where the inspection method is scan inspection, perform printing and image capturing, for creation of a reference image, of one or a plurality of print jobs before a print job targeted for inspection and transmit the captured image as a reference image to the inspection apparatus 0108. The inspection apparatus 0108 then stores the received image as a reference image in a storage unit 0228.

A CPU 0221 performs control and computation operations on respective units included in the large-capacity stacker 0107 via a system bus 0224, and performs execution of a program which is stored in a storage unit 0248 and is then loaded onto a RAM 0222. The RAM 0222 is a type of general volatile storage device which the CPU 0221 is able to directly access, and is used as a work area for the CPU 0221 or an additional temporary data storage region. The storage unit 0248 functions as a temporary storage region and a work memory during an operation of the inspection apparatus 0108. A paper discharge unit 0223 performs monitoring and control operations for a paper discharge operation to the main tray and the top tray and for the respective stacking statuses of the main tray and the top tray.

A CPU 0226 performs control and computation operations on respective units included in the inspection apparatus 0108 via a system bus 0230, and performs execution of a program which is stored in the storage unit 0228 and is then loaded onto a RAM 0227. The RAM 0227 is a type of general volatile storage device which the CPU 0226 is able to directly access, and is used as a work area for the CPU 0226 or an additional temporary data storage region. The storage unit 0228 functions as a temporary storage region and a work memory during an operation of the inspection apparatus 0108. A page description language (PDL) analysis unit 0229 reads PDL data, such as Portable Document Format (PDF), PostScript, or Printer Command Language (PCL), of a print job received from the client computer 0110 or the information processing apparatus 0109. Then, the PDL analysis unit 0229 performs interpretation processing on the read PDL data. A display unit 0245, which is, for example, a liquid crystal display connected to the inspection apparatus 0108, receives an input to the inspection apparatus 0108 from the user and displays a state of the inspection apparatus 0108. The CPU 0226, serving as a display control unit, performs control of a screen which the display unit 0245 displays.

The CPU 0226 obtains a difference (the absolute value of a difference) between the pixel value of a selected pixel and the pixel value of a pixel included in a comparative reference image and corresponding to the selected pixel and determines whether the obtained difference is greater than or equal to a threshold value. Then, if it is determined that the difference is greater than or equal to the threshold value, the CPU 0226 determines that the selected pixel is a no-good (NG) image. On the other hand, if it is determined that the difference is less than the threshold value, the CPU 0226 does not determine that the selected pixel is an NG image. Additionally, the CPU 0226 determines whether an image region configured with an aggregate of NG pixels meets the standard of an inspection corresponding to the set inspection level. If it is determined that the image region configured with an aggregate of NG pixels meets the standard of an inspection corresponding to the set inspection level, the CPU 0226 determines that there is no defect. On the other hand, if it is determined that the image region configured with an aggregate of NG pixels does not meet the standard of an inspection corresponding to the set inspection level, the CPU 0226 determines that there are some defects.

A CPU 0234 performs control and computation operations on respective units included in the information processing apparatus 0109 via the system bus 0239, and performs execution of a program which is stored in a storage unit 0236 and is then loaded onto a RAM 0235. The RAM 0235 is a type of general volatile storage device which the CPU 0234 is able to directly access, and is used as a work area for the CPU 0234 or an additional temporary data storage region. The storage unit 0236 functions as a temporary storage region and a work memory during an operation of the information processing apparatus 0109. A network interface (NW I/F) 0237 is connected to an NW I/F 0240 via the network 0113. Moreover, the information processing apparatus 0109 performs communication with the client computer 0110 via the NW I/F 0237 and the NW I/F 0240.

Moreover, a configuration in which the inspection apparatus 0108 includes an NW I/F and the information processing apparatus 0109 performs communication with the inspection apparatus 0108 via the NW I/F of the inspection apparatus 0108 and the NW I/F 0237 can be employed. For example, consider a case where the inspection method to be used is a raster image processing (RIP) inspection and the reference image to be used is an RIP image which the printing apparatus 0101 uses for printing. In this case, the reference image can be transmitted to the inspection apparatus 0108 via the inspection apparatus I/F 0215, or can be transmitted from the NW I/F included in the inspection apparatus 0108 to the inspection apparatus 0108 via the NW I/F 0207 and the NW I/F 0237.

A CPU 0243 performs control and computation operations on respective units included in the client computer 0110 via a system bus 0246, and performs execution of a program which is stored in a storage unit 0244 and is then loaded onto a RAM 0242. The RAM 0242 is a type of general volatile storage device which the CPU 0243 is able to directly access, and is used as a work area for the CPU 0243 or an additional temporary data storage region. The storage unit 0244 functions as a temporary storage region and a work memory during an operation of the client computer 0110.

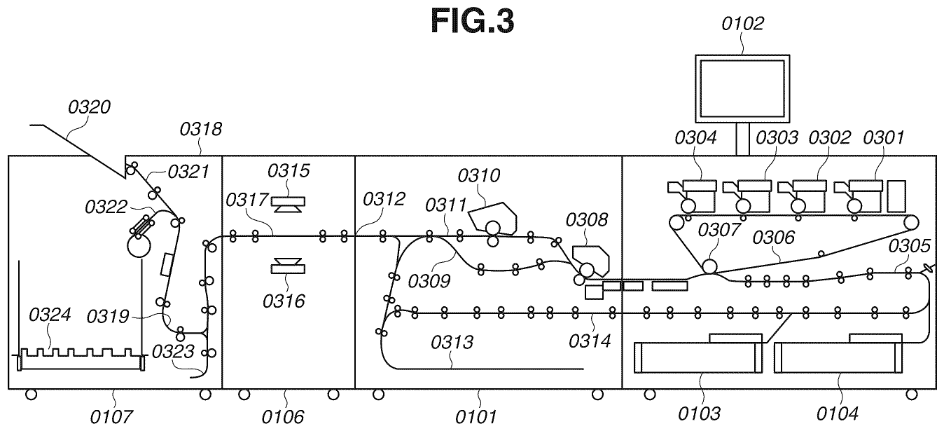

FIG. 3 is a diagram illustrating internal configurations of the printing apparatus 0101, the inspection unit 0106, and the large-capacity stacker 0107. The printing apparatus 0101 is configured to receive an input from the user via the UI panel 0102 and to display states of printing and respective apparatuses. The paper feed decks 0103 and 0104 allow various types of sheets of paper to be contained therein. Each of the paper feed decks 0103 and 0104 is able to separate only one sheet of paper located at the top of the contained sheets of paper and then convey the separated sheet of paper to a sheet conveyance path 0305. Development stations 0301 to 0304 form toner images with use of colored toners of yellow (Y), magenta (M), cyan (C), and black (K), respectively, to form a color image. The toner images formed here are primarily transferred to an intermediate transfer belt 0306. The intermediate transfer belt 0306 rotates clockwise as viewed in FIG. 3, so that, at a secondary transfer position 0307, the toner images are transferred to a sheet of paper conveyed from the sheet conveyance path 0305. A fixing unit 0308 includes a pressure roller and a heating roller, and, when the sheet of paper passes through between the pressure roller and the heating roller, fixes the toner images to the sheet of paper by fusing and firmly pressing the toners. The sheet of paper having exited from the fixing unit 0308 passes through a sheet conveyance path 0309 and is then conveyed to an opening 0312. In a case where it is necessary to perform further fusing and firm pressing for fixing depending on a type of sheet of paper, the sheet of paper after passing through the fixing unit 0308 is conveyed to a second fixing unit 0310 through an upper sheet conveyance path, and, after being subjected to further fusing and firm pressing, is sequentially conveyed to the opening 0312 through a sheet conveyance path 0311. In a case where the image forming mode is duplex printing, the sheet of paper is conveyed to a sheet inversion path 0313, is inverted by the sheet inversion path 0313, and is then conveyed to a duplex conveyance path 0314, so that image transfer for the second surface of the sheet of paper is performed at the secondary transfer position 0307.

Inside the inspection unit 0106, CISs 0315 and 0316 are arranged facing each other. The CIS 0315 is a sensor for reading the upper surface of a sheet of paper, and the CIS 0316 is a sensor for reading the lower surface of a sheet of paper. The inspection unit 0106 performs reading at timing when a sheet of paper sequentially conveyed from a sheet conveyance path 0317 has arrived at a predetermined position, by scanning the sheet of paper with use of the CISs 0315 and 0316. A read image (scanned image) obtained by scanning the sheet of paper is transmitted to the inspection apparatus 0108 via the inspection apparatus I/F 0215 and the inspection unit I/F 0231. The CPU 0226 of the inspection apparatus 0108 determines whether the image acquired by receiving the scanned image has any defect, and communicates a result of determination to the inspection unit 0106 via the inspection unit I/F 0231 and the inspection apparatus I/F 0215. The CPU 0216 communicates the received result of determination to the large-capacity stacker 0107 via the accessory I/Fs 0214 and 0220.

The large-capacity stacker 0107 allows a large number of sheets of paper to be stacked therein. The large-capacity stacker 0107 includes a main tray 0324 as a tray used for stacking sheets of paper thereon. A sheet of paper having passed through the inspection unit 0106 enters the large-capacity stacker 0107 through a sheet conveyance path 0319. The sheet of paper is stacked on the main tray 0324 from the sheet conveyance path 0319 via a sheet conveyance path 0322. Additionally, the large-capacity stacker 0107 includes a top tray 0320 as a sheet discharge tray.

The CPU 0221 discharges, to the top tray 0320, a sheet of paper in which a defect has been detected by the inspection apparatus 0108. In the case of discharging a sheet of paper to the top tray 0320, the sheet of paper is conveyed from the sheet conveyance path 0319 to the top tray 0320 via a sheet conveyance path 0321. An inversion unit 0323 is arranged to invert a sheet of paper. The inversion unit 0323 is used in the case of stacking a sheet of paper on the main tray 0324. In the case of stacking a sheet of paper on the main tray 0324 in such a manner that the orientation of a sheet of paper having entered the large-capacity stacker 0107 and the orientation of the sheet of paper having been stacked become coincident with each other, the sheet of paper is inverted once at the inversion unit 0323. In the case of conveying a sheet of paper to the top tray 0320, since the sheet of paper is directly discharged without being flipped at the time of stacking, an inverting operation using the inversion unit 0323 is not performed.

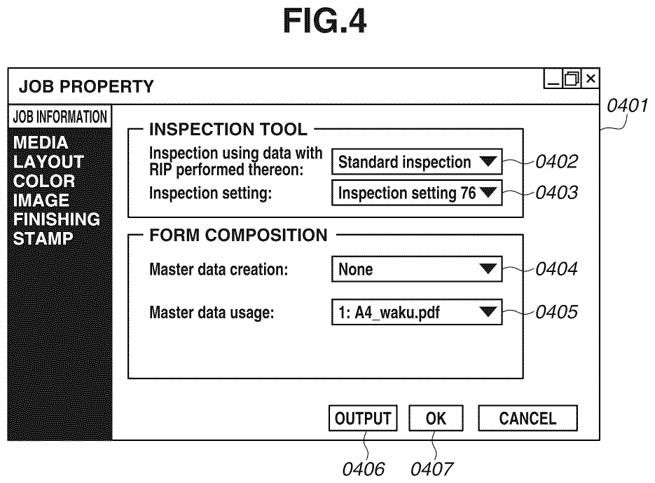

FIG. 4 is a diagram illustrating an example of a setting screen for a print job which is to be processed by the information processing apparatus 0109. A setting screen 0401, which is a setting screen for a print job, includes inspection method 0402, inspection setting 0403, master data creation setting 0404, which is used for form composition, and master data usage setting 0405. In the first exemplary embodiment, a form composition image which is used for form composition is referred to as “master data” and a “master data image”. By performing form composition, the master data image is repeatedly used between pages.

The inspection method 0402 includes options for inspection methods, i.e., off, standard inspection, frequently used inspection setting, and new inspection setting. If the result of determination as to inspection setting in step S0802 described below is YES, any one of standard inspection, frequently used inspection setting, and new inspection setting is set as the inspection method 0402 and is used for inspection of an output product. If the result of determination as to inspection setting in step S0802 is NO, off is selected as the inspection method 0402, and, in this case, inspection of an output product is not performed.

The inspection setting 0403 includes options for selecting inspection setting preliminarily registered to be used for inspection. For example, the inspection setting 0403 is used for the case of inspecting a print image which is repeatedly used. Specifically, inspection setting for a print image which is repeatedly used is preliminarily registered as “inspection setting 76”, and, at the time of inspection of the print image for the subsequent times, the registered “inspection setting 76” is selected. This enables performing inspection processing without performing inspection setting for each time at the time of inspection of a print image which is repeatedly used. The method of registering inspection setting is omitted from description.

The mask data creation setting 0404 includes options for registering master data.

The options indicate a storage portion 1 to a storage portion 100 included in the storage unit 0236 of the information processing apparatus 0109, and selecting one of the options causes master data to be stored in the storage unit 0236 of the information processing apparatus 0109.

The master data usage setting 0405 includes options for issuing an instruction for reading out master data retained in the storage unit 0236 of the information processing apparatus 0109 and combining the read-out master data with a print job. While, in FIG. 4, as an example, the data name of registered master data is used as an option in the master data usage setting 0405, an identifier (ID) specific to master data or a name set by the user can be used for selection, and the options in the master data usage setting 0405 are not limited. Composition which is used here is what is called form composition, and a form image which is used in form composition is referred to as “master data”. The master data is printed in all of the pages, and includes, for example, a logo image for a company, a frame image for an award certificate, and a background image for a printed product.

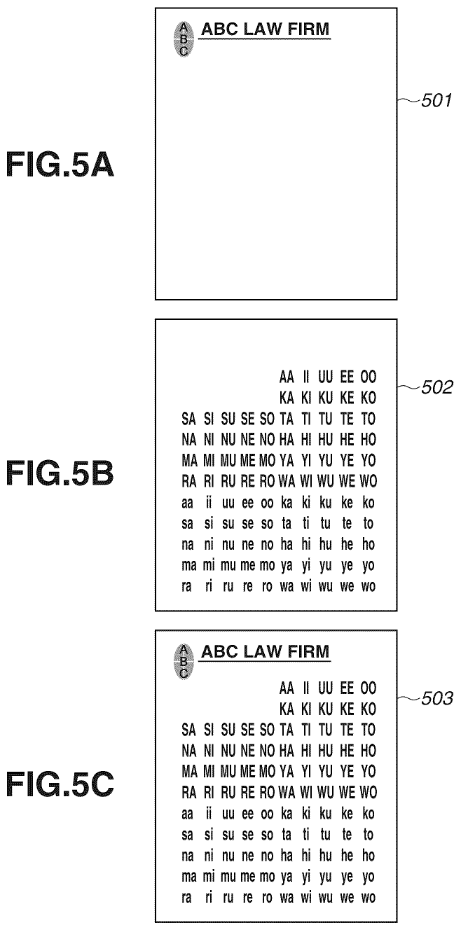

FIGS. 5A, 5B, and 5C are diagrams illustrating a reference image and content region information which are used by the printing apparatus 0101 and the inspection apparatus 0108 in the first exemplary embodiment.

In the first exemplary embodiment, for example, images which the information processing apparatus 0109 processes include a master data image 0501 illustrated in FIG. 5A, which is an image for master data, and a variable data image 0502 illustrated in FIG. 5B, which is an image for variable data. A composite data image 0503 illustrated in FIG. 5C is obtained by combining the master data image 0501 and the variable data image 0502 with each other. An RIP image for the composite data image 0503 illustrated in FIG. 5C is obtained by performing image composition on RIP images obtained from the master data image 0501 and the variable data image 0502. The RIP image, which is data expressed with an eight-bit digital signal for each pixel, is used for print processing to be performed by the printing apparatus 0101 and is also used as a reference image by the inspection apparatus 0108.

Each of the master data image 0501 and the variable data image 0502 is PDL data output from the application installed on the client computer 0110. The CPU 0201 of the printing apparatus 0101 performs raster image processor (RIP) processing on the master data image 0501 and the variable data image 0502, thus creating respective RIP images. The RIP image (bitmap image) for the master data image 0501 is hereinafter referred to as “master data”. The RIP image (bitmap image) for the variable data image 0502 is hereinafter referred to as “variable data”.

Furthermore, with regard to each of the master data image 0501 and the variable data image 0502, the attribute of content contained in the data is expressed by PDL commands. Therefore, analyzing PDL commands enables knowing to which image object a drawn line or character string corresponds. Thus, examining pixels of an RIP image obtained by RIP processing enables knowing the attribute (image region attribute) of drawn content. In the first exemplary embodiment, the image region attribute to be used includes graphic, image, and text.

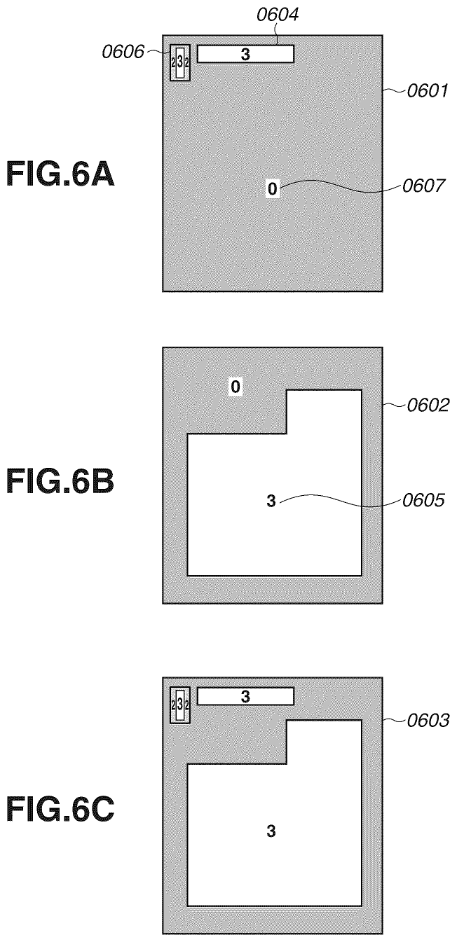

FIGS. 6A, 6B, and 6C are diagrams illustrating content region information for image composition data obtained by combining content region information for master data and content region information for variable data in the first exemplary embodiment.

Content region information 0601 illustrated in FIG. 6A includes an image region attribute which is obtained by performing RIP processing on the master data image 0501. Content region information 0602 illustrated in FIG. 6B includes an image region attribute which is obtained by performing RIP processing on the variable data image 0502. Content region information 0603 illustrated in FIG. 6C includes an image region attribute of the composite data image 0503 which is obtained by combining the master data image 0501 and the variable data image 0502 with each other.

Here, the content region information 0603 is used as information about an inspection region in inspecting the composite data image 0503. Specifically, when the composite data image 0503 is registered as a reference image, content region information 0601 and content region information 0602 about the master data image 0501 and the variable data image 0502, respectively, are generated. Content region information 0603 obtained by combining the content region information 0601 and the content region information 0602 with each other is used as information about an inspection region.

Then, with respect to the content region information 0601, the content region information 0602, and the content region information 0603, numerals of “0 (none)”, “1 (graphic)”, “2 (image)”, and “3 (text)” are allocated to the image region attributes for each pixel. Aggregates of pixels of text attribute are text attribute 0604 and text attribute 0605. An aggregate of pixels of image attribute is image attribute 0606. An aggregate of pixels of attribute nothing is attribute nothing 0607. Although not illustrated, if there is an aggregate of pixels of graphic attribute, there is graphic attribute.

Furthermore, the types of contents to be used in the inspection system are not limited to such three types as graphic, image, and text, and, in a case where there is content other than the three types from among various printing contents, such content can be added as a new definition. Furthermore, the things which are able to be registered as a preset can be not only master data and content region information about the master data but also image data obtained by composition and content region information about the image data.

The preset is displayed in the inspection setting 0403 illustrated in FIG. 4, and a stored inspection region setting is used in response to designation using the inspection setting 0403. The preset includes region information and an inspection level which are used at the time of inspection. The stored inspection region setting can be used in units of pages or in the entire job.

However, the setting which is to be included in the present is not limited to region information and an inspection level which are used at the time of inspection. The setting can be a type or attribute of region information which is used at the time of inspection.

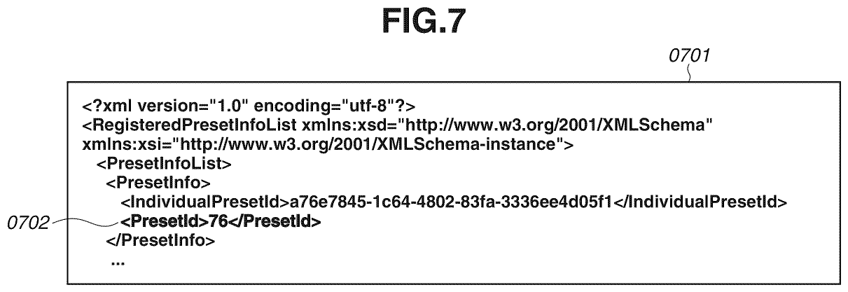

FIG. 7 is a diagram illustrating inspection region setting in master data in the first exemplary embodiment.

Inspection region information 0701 is inspection region setting of a preset of master data which is retained in the storage unit 0228 of the inspection apparatus 0108. Here, master data and an identifier (ID) specific to the master data are stored while being associated with each other.

An ID 0702 is an ID which is written in the inspection region information 0701 and represents master data.

At the time of performing an inspection of the composite data image 0503, the ID 0702 is used to call up inspection region setting of a master data portion of the composite data image 0503 retained in the storage unit 0228 of the inspection apparatus 0108.

Moreover, the ID 0702 uses, as an ID, a number of the retention destination which is used for master data to be retained in the storage unit 0236 of the information processing apparatus 0109. However, the ID 0702 is not limited to a setting method for an ID. The ID 0702 can be an optional value which is generated from, for example, the date and time at which master data was retained in the storage unit 0236 of the information processing apparatus 0109.

On the other hand, inspection region setting of variable data is also able to be stored as a preset in the storage unit 0228 of the inspection apparatus 0108. As with the preset of master data, the preset of variable data also includes region information and an inspection level which are used at the time of inspection. The stored inspection region setting can be used in units of pages or in the entire job. However, unlike the preset of master data, the inspection region setting does not have the ID 0702 written therein.

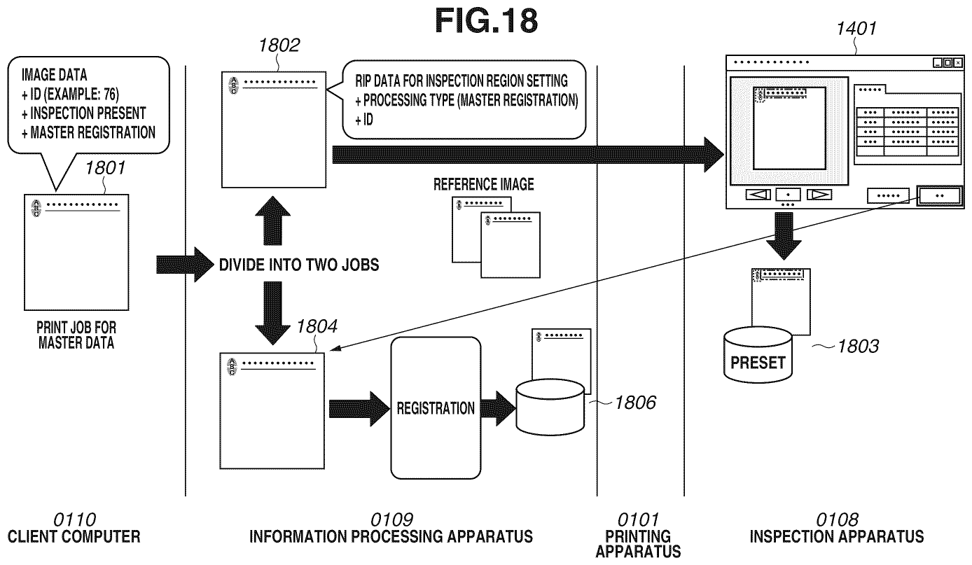

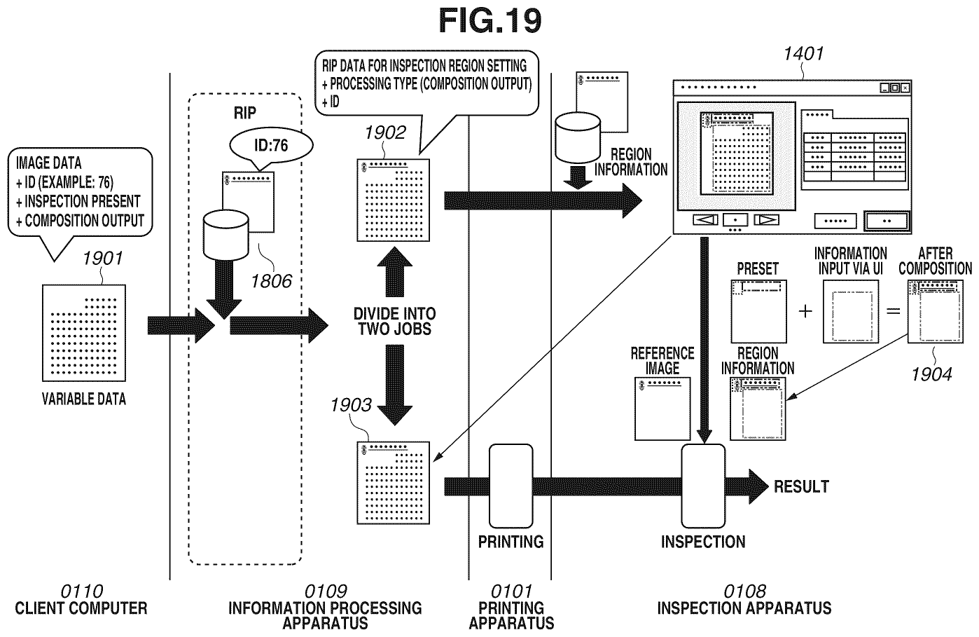

Next, processing which the inspection system performs in the first exemplary embodiment is described with reference to FIG. 18 and FIG. 19.

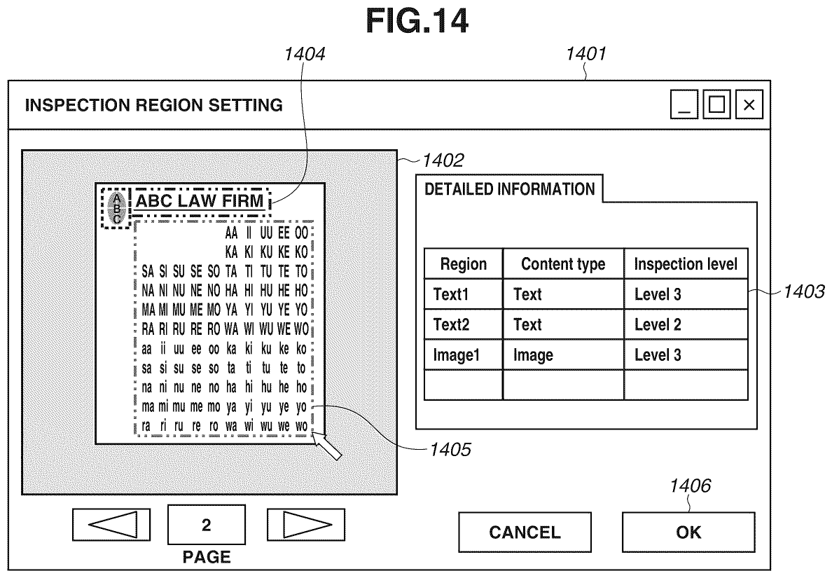

FIG. 18 is a diagram illustrating master data registration processing which the information processing apparatus 0109 and the inspection apparatus 0108 perform in the first exemplary embodiment. A print job 1801 for master data is created by the client computer 0110. The print job 1801 for master data includes, in addition to the print setting which has been set via a setting screen for a print job illustrated in FIG. 4, an ID 0702 indicating master data, the presence or absence of inspection, and registration setting as master data. Then, the client computer 0110 transmits the print job 1801 for master data to the information processing apparatus 0109. The information processing apparatus 0109, having received the print job 1801 for master data, creates image data 1802, which serves as a reference image to be used by the inspection apparatus 0108 at the time of performing RIP processing on image data, and image data 1804, which is to be stored in the information processing apparatus 0109. The image data 1802 is sent from the information processing apparatus 0109 to the inspection apparatus 0108. The inspection apparatus 0108 uses the image data 1802 as a display image for registering inspection setting at an inspection setting screen 1401 illustrated in FIG. 14 described below, and registers the image data as a preset 1803 at the storage unit 0228 of the inspection apparatus 0108. Upon ending of the registration, the information processing apparatus 0109 stores the image data 1804 as master data 1806 in the storage unit 0236 of the information processing apparatus 0109.

FIG. 19 is a diagram illustrating composition processing for master data and variable data which the information processing apparatus 0109 and the inspection apparatus 0108 perform in the first exemplary embodiment.

A print job 1901 for variable data is created by the client computer 0110. The print job 1901 for variable data includes, in addition to the print setting which has been set via a setting screen for a print job illustrated in FIG. 4, an ID 0702 indicating master data to be combined with the variable data, the presence or absence of inspection, and output setting as variable data. Then, the client computer 0110 transmits the print job 1901 for variable data to the information processing apparatus 0109. The information processing apparatus 0109, having received the print job 1901 for variable data, creates image data 1902, which serves as a reference image to be used by the inspection apparatus 0108 at the time of performing RIP processing on image data, and image data 1903, which is to be output by the printing apparatus 0101. The image data 1902 is sent from the information processing apparatus 0109 to the inspection apparatus 0108. The inspection apparatus 0108 uses the image data 1902 as a display image for registering inspection setting at the inspection setting screen 1401 illustrated in FIG. 14 described below. Additionally, the image data 1902 is combined with the inspection setting of the present 1803 retained in the storage unit 0228 of the inspection apparatus 0108 after ending of inspection region setting. In the inspection setting screen 1401, the image data 1902 is displayed on the screen, and information about the inspection region registered as a preset is displayed in such a way as to be superimposed on the image data. With regard to displaying of the inspection region here, an image, such as that illustrated as an image 1904, obtained by combining the inspection region registered as a preset and the inspection region input from the user with each other is displayed. In response to registration of the inspection setting being ended at the inspection setting screen 1401, the information processing apparatus 0109 sends the image data 1903 to the printing apparatus 0101, thus starting printing. Then, the inspection apparatus 0108 inspects an image obtained by capturing an image of the printed output product and the image data 1902, and outputs a result of the inspection.

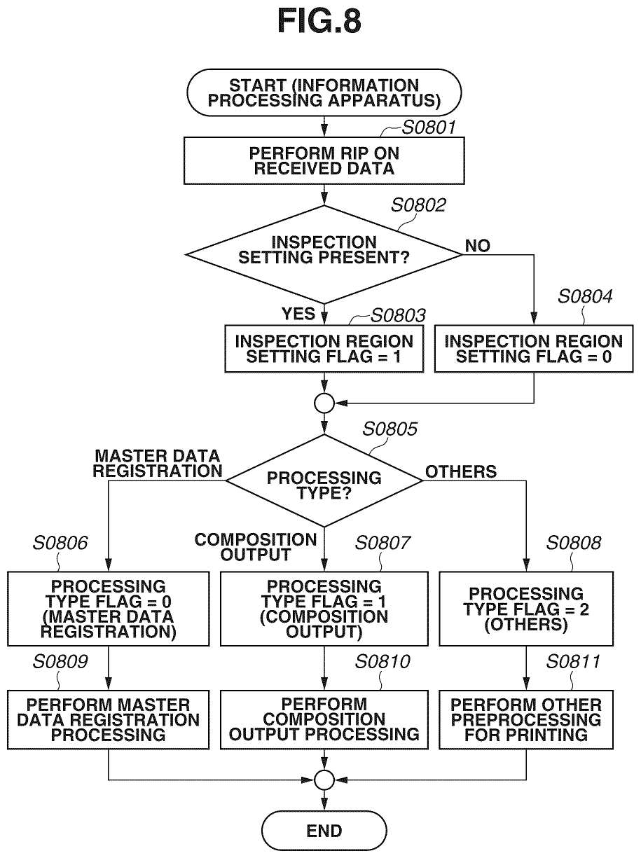

Next, flowcharts of processing which the inspection system performs in the first exemplary embodiment are described with reference to FIG. 8 to FIG. 13. FIG. 8 to FIG. 10 are flowcharts of processing which the information processing apparatus 0109 performs.

FIG. 8 is a flowchart illustrating preprocessing which the information processing apparatus 0109 performs when performing image composition for a print job in the first exemplary embodiment. The flowchart of FIG. 8 is implemented by the CPU 0234 of the information processing apparatus 0109 reading out a program stored in the storage unit 0236 onto the RAM 0235 and executing the program.

In step S0801, the CPU 0234 performs RIP processing on a printing image included in a print job input from the client computer 0110 to the information processing apparatus 0109, thus generating an RIP image. Here, in the RIP processing, analysis of a PDL command included in the print job is performed.

In step S0802, the CPU 0234 determines the presence or absence of inspection setting for the received print job. If it is determined that inspection is necessary (YES in step S0802), the CPU 0234 advances the processing to step S0803. If it is determined that inspection is unnecessary (NO in step S0802), the CPU 0234 advances the processing to step S0804.

In step S0803, the CPU 0234 sets “1” (implementation) to an inspection region setting flag, which indicates implementation or non-implementation of inspection, retained in the RAM 0235 of the information processing apparatus 0109. Then, the CPU 0234 advances the processing to step S0805.

In step S0804, the CPU 0234 sets “0” (non-implementation) to the inspection region setting flag, which indicates implementation or non-implementation of inspection, retained in the RAM 0235 of the information processing apparatus 0109.

Then, the CPU 0234 advances the processing to step S0805.

Next, in step S0805, the CPU 0234 determines a processing type included in the print job.

If it is determined that the processing type is to retain the print job for image composition in the storage unit 0236 of the information processing apparatus 0109 (MASTER DATA REGISTRATION in step S0805), the CPU 0234 advances the processing to step S0806. If it is determined that the processing type is to perform image composition with master data retained in the storage unit 0236 of the information processing apparatus 0109 (COMPOSITION OUTPUT), the CPU 0234 advances the processing to step S0807. If it is determined that the processing type is the others (OTHERS in step S0805), the CPU 0234 advances the processing to step S0808.

In step S0806, the CPU 0234 sets “0” (master data registration) to a processing type flag, which indicates a processing method for master data, retained in the RAM 0235 of the information processing apparatus 0109. Then, the CPU 0234 advances the processing to step S0809.

In step S0807, the CPU 0234 sets “1” (composition output) to the processing type flag retained in the RAM 0235 of the information processing apparatus 0109. Then, the CPU 0234 advances the processing to step S0810.

In step S0808, the CPU 0234 sets “2” (others) to the processing type flag retained in the RAM 0235 of the information processing apparatus 0109. Then, the CPU 0234 advances the processing to step S0811.

In step S0809, the CPU 0234 performs processing for generating master data from the print job for image composition described below and retaining the master data in the storage unit 0236 of the information processing apparatus 0109.

At this time, an ID specific to the master data is issued, and the issued ID is transmitted to the inspection apparatus 0108. Then, the CPU 0234 ends the processing.

In step S0810, the CPU 0234 performs processing for image composition to combine master data retained in the storage unit 0236 of the information processing apparatus 0109 and variable data input from the client computer 0110 with each other. In the first exemplary embodiment, the CPU 0234, which serves as a composition processing unit, performs composition processing to combine master data and a printing image with each other. Then, the CPU 0234 ends the processing.

In step S0811, the CPU 0234 performs preprocessing for printing which is related to neither retention of master data in the storage unit 0236 of the information processing apparatus 0109 nor image composition with master data retained in the storage unit 0236 of the information processing apparatus 0109. The print processing which is not related to composition is general preprocessing for printing and is, therefore, omitted from description. Then, the CPU 0234 ends the processing.

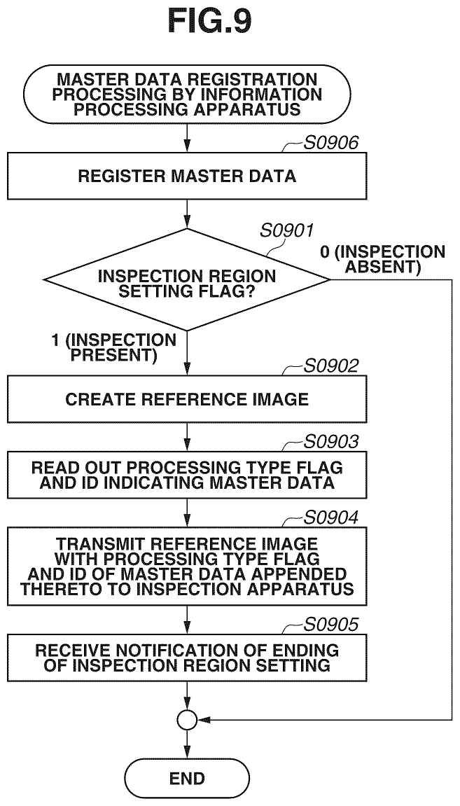

FIG. 9, which corresponds to the details of step S0809, is a flowchart illustrating processing for retaining a print job as a master data in the storage unit 0236 of the information processing apparatus 0109 in the first exemplary embodiment. The flowchart of FIG. 9 is implemented by the CPU 0234 of the information processing apparatus 0109 reading out a program stored in the storage unit 0236 onto the RAM 0235 and executing the program.

First, in step S0906, the CPU 0234 registers master data with the information processing apparatus 0109. Here, the CPU 0234 issues an identifier specific to master data and registers the ID in the storage unit 0236 of the information processing apparatus 0109. In the first exemplary embodiment, the identifier specific to master data is mentioned as an ID.

The form of storage of the ID of master data is as mentioned above with reference to FIG. 7.

In step S0901, the CPU 0234 determines the inspection region setting flag retained in the RAM 0235 of the information processing apparatus 0109. If it is determined that inspection is necessary (1 (INSPECTION PRESENT) in step S0901), the CPU 0234 advances the processing to step S0902. If it is determined that inspection is unnecessary (0 (INSPECTION ABSENT) in step S0901), the CPU 0234 ends the processing.

In step S0902, the CPU 0234 creates an RIP image to be used as a reference image by the inspection apparatus 0108. Specifically, the CPU 0234 duplicates the RIP image created in step S0801. Then, the CPU 0234 advances the processing to step S0903. Furthermore, the RIP image created here is, for example, the master data image 0501 illustrated in FIG. 5A.

In step S0903, the CPU 0234 reads out the ID 0702, which indicates master data, retained in the storage unit 0236 of the information processing apparatus 0109 and the processing type flag retained in the RAM 0235 of the information processing apparatus 0109. Then, the CPU 0234 advances the processing to step S0904.

In step S0904, the CPU 0234 appends the read-out ID 0702 of master data and the read-out processing type flag to the image created as a reference image in step S0902, and sends the reference image with the ID 0702 and the processing type flag appended thereto to the inspection apparatus 0108. Then, the CPU 0234 advances the processing to step S0905. Furthermore, the reference image which has been sent here is not a reference image which is used for comparison in inspection processing but a reference image which is used in performing inspection region setting to be registered as a preset in the inspection apparatus 0108.

In step S0905, the CPU 0234 receives, from the inspection apparatus 0108, an ending notification of an inspection region input performed by the user. Then, the CPU 0234 ends the processing.

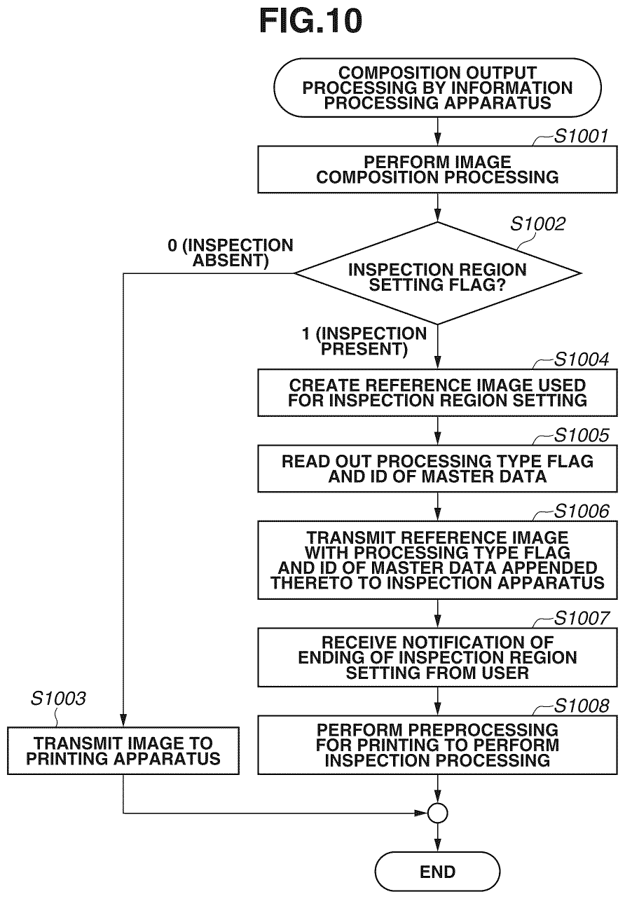

FIG. 10, which corresponds to the details of step S0810, is a flowchart illustrating processing for combining a print job retained in the storage unit 0236 of the information processing apparatus 0109 and a print job input from the client computer 0110 with each other in the first exemplary embodiment. The flowchart of FIG. 10 is implemented by the CPU 0234 of the information processing apparatus 0109 reading out a program stored in the storage unit 0236 onto the RAM 0235 and executing the program.

In step S1001, the CPU 0234 performs image composition processing to combine variable data of the print job input from the client computer 0110 and master data retained in the storage unit 0236 of the information processing apparatus 0109 with each other.

The print job including master data is subjected to image composition processing with master data set via the master data usage setting 0405 illustrated in FIG. 4.

Then, the CPU 0234 advances the processing to step S1002.

In step S1002, the CPU 0234 determines the inspection region setting flag retained in the RAM 0235 of the information processing apparatus 0109. If it is determined that inspection is necessary (1 (INSPECTION PRESENT) in step S1002), the CPU 0234 advances the processing to step S1004. If it is determined that inspection is unnecessary (0 (INSPECTION ABSENT) in step S1002), the CPU 0234 advances the processing to step S1003.

In step S1003, to cause the printing apparatus 0101 to perform printing, the CPU 0234 transmits the image obtained by image composition in step S1001 to the printing apparatus 0101. Then, the CPU 0234 ends the processing.

In step S1004, the CPU 0234 creates an RIP image to be used as a reference image by the inspection apparatus 0108. Specifically, the CPU 0234 duplicates the RIP image created in step S1001. Then, the CPU 0234 advances the processing to step $1005.

In step S1005, the CPU 0234 reads out the ID 0702 of master data and the processing type flag retained in the RAM 0235 of the information processing apparatus 0109. Then, the CPU 0234 advances the processing to step S1006.

In step S1006, the CPU 0234 appends the read-out ID 0702 of master data and the read-out processing type flag to the image created as a reference image in step S1001, and sends the reference image with the ID 0702 and the processing type flag appended thereto to the inspection apparatus 0108. Then, the CPU 0234 advances the processing to step S1007.

In step S1007, the CPU 0234 receives, from the inspection apparatus 0108, an ending notification of an inspection region input performed by the user. Then, the CPU 0234 advances the processing to step S1008.

In step S1008, to cause the printing apparatus 0101 to perform printing for inspection processing, the CPU 0234 transmits the image obtained by image composition in step S1001 to the printing apparatus 0101. Then, the CPU 0234 ends the processing.

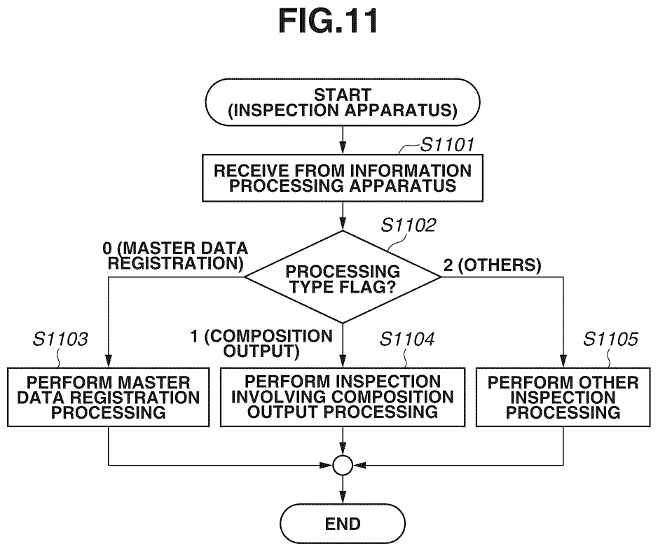

FIG. 11 to FIG. 13 are flowcharts illustrating processing which the inspection apparatus 0108 performs. FIG. 11 is a flowchart illustrating preprocessing which the inspection apparatus 0108 performs to inspect image composition data obtained by image composition in the first exemplary embodiment. The flowchart of FIG. 11 is implemented by the CPU 0226 of the inspection apparatus 0108 reading out a program stored in the storage unit 0228 onto the RAM 0227 and executing the program.

In step S1101, the CPU 0226 receives the ID 0702 of master data, the processing type flag, and the reference image, which have been sent from the information processing apparatus 0109 in step S1006. Then, upon the completion of reception from the information processing apparatus 0109, the CPU 0226 advances the processing to step S1102.

In step S1102, the CPU 0226 determines the received processing type flag. If it is determined that the processing type flag indicates registration of master data (0 (MASTER DATA REGISTRATION) in step S1102), the CPU 0226 advances the processing to step S1103. If it is determined that the processing type flag indicates composition output (1 (COMPOSITION OUTPUT) in step S1102), the CPU 0226 advances the processing to step S1104. If it is determined that the processing type flag indicates the others (2 (OTHERS) in step S1102), the CPU 0226 advances the processing to step S1105.

In step S1103, the CPU 0226 performs processing for retaining a preset of master data described below in the storage unit 0228 of the inspection apparatus 0108. Then, the CPU 0226 ends the processing.

In step S1104, the CPU 0226 performs composition processing described below to combine inspection region setting of the present of master data retained in the storage unit 0228 of the inspection apparatus 0108 and inspection region setting of variable data with each other, and thus performs execution of inspection processing. Then, the CPU 0226 ends the processing.

In step S1105, the CPU 0226 performs ordinary inspection processing. Here, the ordinary inspection processing refers to inspection processing which involves neither registration of master data nor composition output processing. Then, the CPU 0226 ends the processing.

Furthermore, it is assumed that, in a case where master data registered on the side of the information processing apparatus 0109 has been deleted, inspection region setting having an ID of the master data stored in the inspection apparatus 0108 is also deleted.

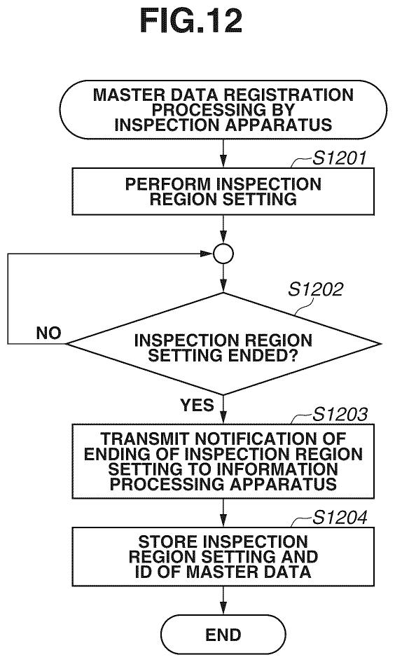

FIG. 12, which corresponds to the details of step S1103, is a flowchart illustrating processing which the inspection apparatus 0108 performs to retain inspection region setting of image composition data in the storage unit 0228 of the inspection apparatus 0108 in the first exemplary embodiment. The flowchart of FIG. 12 is implemented by the CPU 0226 of the inspection apparatus 0108 reading out a program stored in the storage unit 0228 onto the RAM 0227 and executing the program.

In step S1201, to receive inspection region setting for registration as master data from the user, the CPU 0226 displays a reference image received from the information processing apparatus 0109 on the display unit 0245 (FIG. 14). Then, the CPU 0226 advances the processing to step S1202.

In step S1202, the CPU 0226 determines whether inspection region setting by the user has been ended. Specifically, the CPU 0226 determines whether an OK button 1406 illustrated in FIG. 14 has been pressed. If it is determined that the inspection region setting has been ended (YES in step S1202), the CPU 0226 advances the processing to step S1203.

If it is determined that the inspection region setting has not yet been ended (NO in step S1202), the CPU 0226 returns the processing to step S1202.

In step S1203, the CPU 0226 transmits a notification of ending of the inspection region setting to the information processing apparatus 0109. Then, the CPU 0226 advances the processing to step S1204.

In step S1204, the CPU 0226 retains, in the storage unit 0228 of the inspection apparatus 0108, the inspection region setting set by the user and the inspection region information 0701 received from the information processing apparatus 0109 as a preset of master data. Then, the CPU 0226 ends the processing.

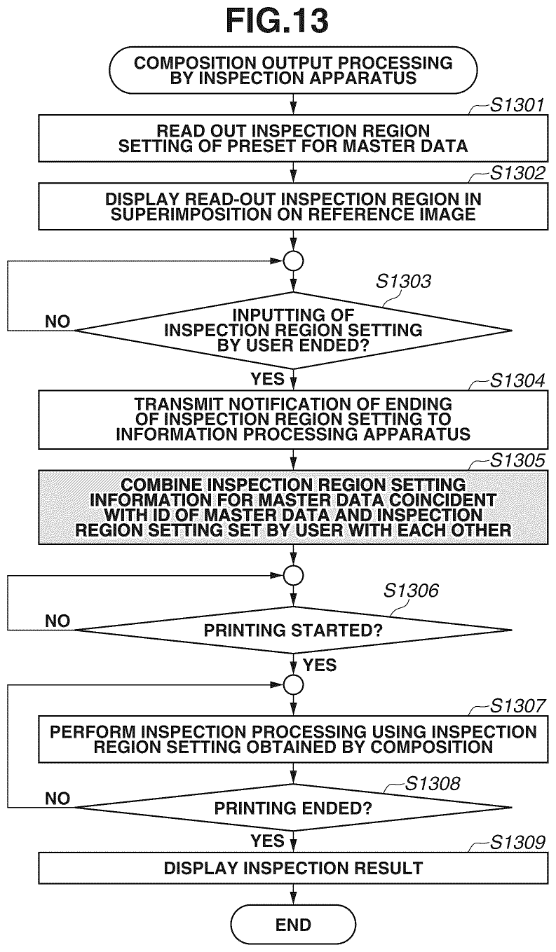

FIG. 13, which corresponds to the details of step S1104, is a flowchart illustrating inspection processing which the inspection apparatus 0108 performs using image composition data obtained by the information processing apparatus 0109 performing image composition in the first exemplary embodiment. The flowchart of FIG. 13 is implemented by the CPU 0226 of the inspection apparatus 0108 reading out a program stored in the storage unit 0228 onto the RAM 0227 and executing the program.

In step S1301, the CPU 0226 reads out inspection region setting coincident with the ID 0702 of master data received from the information processing apparatus 0109 from the inspection region setting of the preset of master data retained in the storage unit 0228 of the inspection apparatus 0108. Then, the CPU 0226 advances the processing to step S1302.

In step S1302, the CPU 0226 displays information about the inspection region setting of the preset of master data read out in step S1301 in superimposition on the reference image for inspection region setting received from the information processing apparatus 0109, thus prompting the user to perform inputting of inspection region setting. Then, the CPU 0226 advances the processing to step S1303.

In step S1303, the CPU 0226 determines whether inputting of inspection region setting by the user has been ended. If it is determined that the inputting of inspection region setting has been ended (YES in step S1303), the CPU 0226 advances the processing to step S1304. If it is determined that the inputting of inspection region setting has not yet been ended (NO in step S1303), the CPU 0226 returns the processing to step S1303.

In step S1304, the CPU 0226 transmits a notification of ending of the inspection region setting to the information processing apparatus 0109. The information processing apparatus 0109, having received the notification, starts printing with use of the printing apparatus 0101. Then, the CPU 0226 advances the processing to step S1305.

In step S1305, the CPU 0226 combines the read-out inspection region setting of the preset of master data and the inspection region setting input by the user with each other. Then, the CPU 0226 advances the processing to step S1306.

In step S1306, the CPU 0226 checks whether printing has been started by the printing apparatus 0101. If it is determined that printing has been started (YES in step S1306), the CPU 0226 advances the processing to step S1307. If it is determined that printing has not yet been started (NO in step S1306), the CPU 0226 returns the processing to step S1306.

In step S1307, the CPU 0226 performs inspection processing of a printed output product with use of the inspection region setting obtained by composition in step S1305. Then, the CPU 0226 advances the processing to step S1308.

In step S1308, the CPU 0226 checks whether printing by the printing apparatus 0101 has been ended. If it is determined that printing has been ended (YES in step S1308), the CPU 0226 advances the processing to step S1309. If it is determined that printing has not yet been ended (NO in step S1308), the CPU 0226 returns the processing to step S1307.

In step S1309, the CPU 0226 displays an inspection result on the display unit 0245 of the inspection apparatus 0108. Then, the CPU 0226 ends the processing.

Next, a setting screen for inspection region setting which is displayed on the inspection apparatus 0108 is described with reference to FIG. 14.

FIG. 14 illustrates a setting screen for inspection region setting which is displayed on the inspection apparatus 0108. In the setting screen, a reference image is displayed, and setting of an inspection region by the user is received on the displayed reference image. The setting screen illustrated in FIG. 14 is displayed on the display unit 0245 of the inspection apparatus 0108 in response to the CPU 0226 of the inspection apparatus 0108 performing the above-mentioned step S1201 or the above-mentioned step S1302. An inspection region interface 1401 is configured with a display portion 1402 for a reference image and detailed setting value information 1403 about an inspection region. FIG. 14 illustrates a setting screen which is displayed in response to processing in step S1302 as an example.

In the display portion 1402 for a reference image, a reference image received from the information processing apparatus 0109, inspection region setting 1404 of a preset of master data retained in the storage unit 0228 of the inspection apparatus 0108, and inspection region setting 1405 input by the user are displayed in a superimposed manner. Here, the inspection region setting 1404 is set to a region equivalent to a master data image included in an image obtained by form composition.

The CPU 0226 displays a reference image which the inspection apparatus 0108 inspects.

With regard to the detailed setting value information 1403 about an inspection region, the CPU 0226 displays a list of setting values of inspection regions which the inspection apparatus 0108 inspects. When there is a change in the detailed setting value information 1403 about an inspection region, the user is allowed to change the setting values by pressing a setting change button 1406.

While, here, the inspection region interface 1401 in the display unit 0245 is displaying the display portion 1402 for a reference image, the detailed setting value information 1403 about an inspection region, and the setting change button 1406, changing of the inspection level or the content type can be performed, and the form of displaying is not limited. Moreover, the example illustrated in FIG. 14 is an example of a result of processing for one sheet of printing paper. For example, in the case of a plurality of sheets of printing paper, if, in processing in step S1308, there is any sheet the inspection result determination about which is not yet processed, the CPU 0226 can return the processing to step S1307 to perform processing for inspection result determination with respect to all of the sheets of paper, and the form of such processing is not limited. Moreover, the example illustrated in FIG. 14 is an example of processing for two print jobs. For example, when master data is kept the same and variable data is changed to different variable data, processing can be performed with use of the ID 0702 to call up inspection region setting for master data, and the form of such processing is not limited. Moreover, the example illustrated in FIG. 14 is an example of processing for two print jobs. For example, when there is a plurality of pieces of master data, processing can be performed while switching a plurality of pieces of master data at each page of variable data, and the form of such processing is not limited.

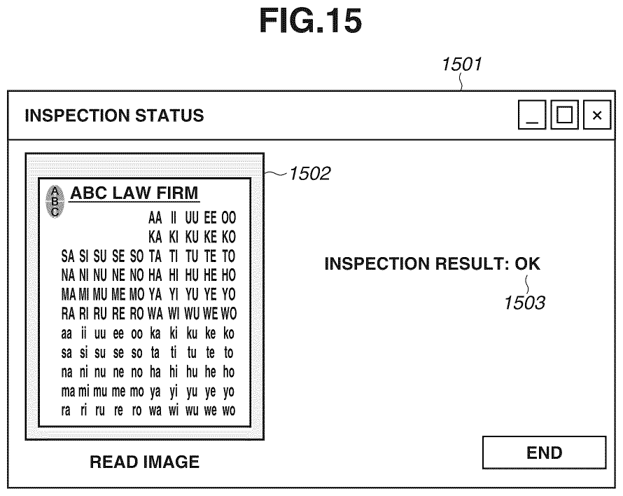

Next, an inspection result display screen which is displayed on the inspection apparatus 0108 is described with reference to FIG. 15. FIG. 15 is a diagram illustrating a screen for inspection status which is displayed on the inspection apparatus 0108. The screen for inspection status illustrated in FIG. 15 is displayed on the display unit 0245 of the inspection apparatus 0108 when the CPU 0226 has performed the above-mentioned processing in step S1307.

An inspection status interface 1501 includes a reference image display portion 1502 and an inspection result 1503. In the reference image display portion 1502, the CPU 0226 displays a reference image which the inspection apparatus 0108 inspects. In the inspection result 1503, the CPU 0226 displays an inspection result obtained in the above-mentioned step S1307. Moreover, while the inspection status interface 1501, which is displayed on the display unit 0245, includes the reference image display portion 1502 and the inspection result 1503, a configuration in which the inspection status interface 1501 is used to display the status of the inspection apparatus 0108 obtained at the time of ending of inspection or information about a job which the inspection apparatus 0108 has inspected can be employed, and the form of such processing is not limited.

In this way, at the time of inspecting an image composition job, combining inspection region setting of master data retained in the storage unit 0228 of the inspection apparatus 0108 and inspection region setting of variable data with each other enables performing inspection of a composite image. Moreover, re-using inspection region setting of master data eliminates the need for performing setting each time. Moreover, since it is possible to re-use inspection region setting of master data, it is possible to lessen an operation of repeatedly performing setting with respect to a plurality of print jobs or a printed product with a large number of pages. Additionally, it is possible to equally perform inspection regardless of print jobs with respect to an inspection position of a portion in which master data is used.

In the above-described first exemplary embodiment, processing for, when retaining a print job with inspection region setting performed thereon in the storage unit 0236 of the information processing apparatus 0109, also simultaneously retaining inspection region setting of master data in the storage unit 0228 of the inspection apparatus 0108 has been described. Moreover, inspection processing which is performed when master data retained in the storage unit 0236 of the information processing apparatus 0109 and variable data input from the client computer 0110 have been combined with each other has been described. However, there is a case where registration of inspection region setting of master data in the storage unit 0228 of the inspection apparatus 0108 is not performed. Therefore, in a second exemplary embodiment, processing which is performed in a case where registration of inspection region setting of master data in the inspection apparatus 0108 is not performed is described.

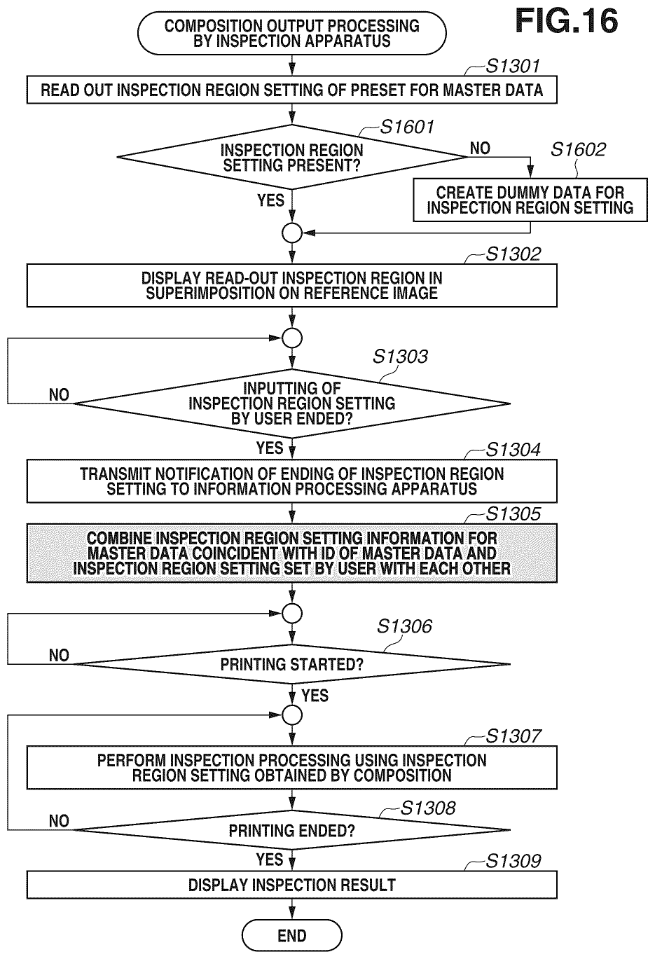

FIG. 16, which corresponds to the details of step S1104, is a flowchart illustrating processing in which the inspection apparatus 0108 inspects image composition data obtained by combining master data the inspection region setting of which is not registered in the inspection apparatus 0108 and variable data input from the client computer 0110 with each other.

The flowchart of FIG. 16 is implemented by the CPU 0226 of the inspection apparatus 0108 reading out a program stored in the storage unit 0228 onto the RAM 0227 and executing the program. In step S1301, the CPU 0226 reads out inspection region setting coincident with the ID 0702 of master data received from the information processing apparatus 0109 from the inspection region setting of the preset of master data retained in the storage unit 0228 of the inspection apparatus 0108. Then, the CPU 0226 advances the processing to step S1601.

In step S1601, the CPU 0226 determines the presence or absence of inspection region setting coincident with an ID indicating master data retained in the storage unit 0228 of the inspection apparatus 0108. If it is determined that the inspection region setting is present (YES in step S1601), the CPU 0226 advances the processing to step S1302.

If it is determined that the inspection region setting is absent (NO in step S1601), the CPU 0226 advances the processing to step S1602.

In step S1602, the CPU 0226 prepares dummy data which does not have inspection region setting. Then, the CPU 0226 advances the processing to step S1302.

In step S1302, the CPU 0226 displays information about the inspection region setting of the dummy data prepared in step S1602 in superimposition on the reference image for inspection region setting received from the information processing apparatus 0109, thus prompting the user to perform inputting of inspection region setting. Then, the CPU 0226 advances the processing to step S1303.

In step S1303, the CPU 0226 determines whether inputting of inspection region setting by the user has been ended. If it is determined that the inputting of inspection region setting has been ended (YES in step S1303), the CPU 0226 advances the processing to step S1304. If it is determined that the inputting of inspection region setting has not yet been ended (NO in step S1303), the CPU 0226 returns the processing to step S1303.

In step S1304, the CPU 0226 transmits a notification of ending of the inspection region setting to the information processing apparatus 0109. The information processing apparatus 0109, having received the notification, starts printing with use of the printing apparatus 0101. Then, the CPU 0226 advances the processing to step S1305.

In step S1305, the CPU 0226 combines the inspection region setting of the preset of master data read out in step S1301 or step S1602 and the inspection region setting input by the user with each other.

Then, the CPU 0226 advances the processing to step S1306.

In step S1306, the CPU 0226 checks whether printing has been started by the printing apparatus 0101. If it is determined that printing has been started (YES in step S1306), the CPU 0226 advances the processing to step S1307. If it is determined that printing has not yet been started (NO in step S1306), the CPU 0226 returns the processing to step S1306.

In step S1307, the CPU 0226 performs inspection processing of a printed output product with use of the inspection region setting obtained by composition in step S1305. Then, the CPU 0226 advances the processing to step S1308.

In step S1308, the CPU 0226 checks whether printing by the printing apparatus 0101 has been ended. If it is determined that printing has been ended (YES in step S1308), the CPU 0226 advances the processing to step S1309. If it is determined that printing has not yet been ended (NO in step S1308), the CPU 0226 returns the processing to step S1307.

In step S1309, the CPU 0226 displays an inspection result on the display unit 0245 of the inspection apparatus 0108. Then, the CPU 0226 ends the processing.

As described above, even in the case of performing form composition of data for which master data registration processing is still not being performed, it is possible to perform setting of an inspection region with use of the configuration described above in the first exemplary embodiment.

In the above-described first exemplary embodiment, processing for, when retaining a print job with inspection region setting performed thereon in the storage unit 0236 of the information processing apparatus 0109, also simultaneously retaining inspection region setting of master data in the storage unit 0228 of the inspection apparatus 0108 has been described. Moreover, processing for combining master data retained in the storage unit 0236 of the information processing apparatus 0109 and variable data input from the client computer 0110 with each other and performing inspection has been described.

In the second exemplary embodiment, processing for combining image data for which inspection region setting of master data is still not registered in the storage unit 0228 of the inspection apparatus 0108 and variable data input from the client computer 0110 with each other and performing inspection has been described.

In a third exemplary embodiment, processing for combining master data for which inspection region setting of a preset of master data is not yet registered in the storage unit 0228 of the inspection apparatus 0108 and variable data input from the client computer 0110 with each other and, in a case where it has been determined that the inspection region setting for the master data is not yet registered, after registering the inspection region setting, performing inspection is described.

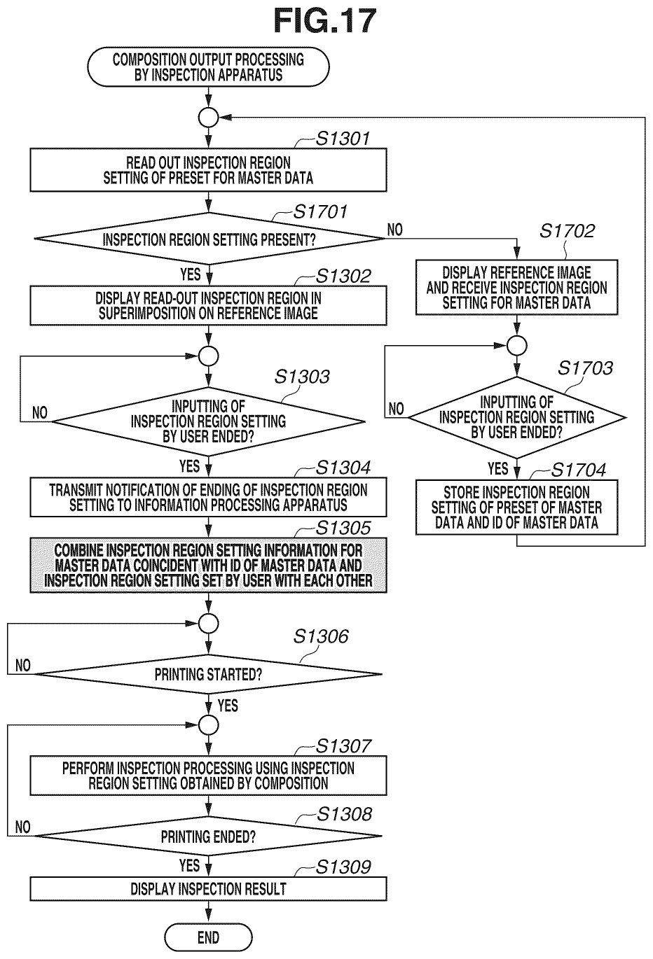

FIG. 17 is a flowchart illustrating processing for inspecting image composition data obtained by combining master data for which content region information about master data is not yet registered and variable data input from the client computer 0110 with each other in the third exemplary embodiment. The flowchart of FIG. 17 is implemented by the CPU 0226 of the inspection apparatus 0108 reading out a program stored in the storage unit 0228 onto the RAM 0227 and executing the program.

In step S1301, the CPU 0226 reads out inspection region setting coincident with the ID 0702 of master data received from the information processing apparatus 0109 from the inspection region setting of the preset of master data retained in the storage unit 0228 of the inspection apparatus 0108. Then, the CPU 0226 advances the processing to step S1701.

In step S1701, the CPU 0226 determines the presence or absence of inspection region setting coincident with an ID indicating master data retained in the storage unit 0228 of the inspection apparatus 0108. If it is determined that the inspection region setting is present (YES in step S1701), the CPU 0226 advances the processing to step S1302.

If it is determined that the inspection region setting is absent (NO in step $1701), the CPU 0226 advances the processing to step S1702.

In step S1702, the CPU 0226 displays a reference image for inspection region setting received from the information processing apparatus 0109, thus prompting the user to perform inputting of inspection region setting of master data. Then, the CPU 0226 advances the processing to step S1703.

In step S1703, the CPU 0226 determines whether inputting of inspection region setting by the user has been ended. If it is determined that the inputting of inspection region setting has been ended (YES in step S1703), the CPU 0226 advances the processing to step S1704. If it is determined that the inputting of inspection region setting has not yet been ended (NO in step S1703), the CPU 0226 returns the processing to step S1703.

In step S1704, the CPU 0226 stores inspection region setting of a preset of master data set by the user and an optional ID representing the master data in the storage unit 0228 of the inspection apparatus 0108. Then, the CPU 0226 returns the processing to step S1301.

Step S1302 to step S1309 are similar to those illustrated in FIG. 13 and FIG. 16.

As described above, in the case of using master data for which the inspection region setting is not yet registered, it is possible to, after performing processing for registration, inspect a composite image.

Embodiments of the present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, embodiments of the present disclosure can also be implemented by a circuit which implements one or more functions of the above-described exemplary embodiments (for example, an application specific integrated circuit (ASIC)).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-086633, filed May 26, 2023, which is hereby incorporated by reference herein in its entirety.

What is claimed is:

1. An inspection apparatus comprising:
a reception unit configured to receive a read image acquired by reading, with a reading unit, each of printed products which are sequentially conveyed and received from an image forming unit;
an inspection unit configured to inspect each of the printed products based on the read image and a preliminarily registered reference image;
a setting unit configured to set an inspection region targeted for an inspection to be performed by the inspection unit; and
a storage unit configured to store information about the inspection region for a first image which is repeatedly used,
wherein the inspection unit inspects a printed product in which a third image obtained by combining the first image and a second image with each other has been printed, based on the inspection region set by the setting unit and the inspection region for the first image the information about which has been stored in the storage unit.

2. The inspection apparatus according to claim 1,
wherein the inspection apparatus further comprises a display control unit configured to display a screen on a display unit,
wherein the setting unit receives an instruction for an inspection region on the reference image displayed on the display unit by the display control unit, thereby performing setting of the inspection region, and
wherein, with respect to a third image obtained by a first image which is repeatedly used between pages and a second image with each other, the display control unit displays an inspection region based on the information stored in the storage unit on an image equivalent to the first image included in the third image displayed on the display unit.

3. The inspection apparatus according to claim 1, wherein the storage unit stores setting of an inspection region set from a user on the first image by the setting unit, as information about the inspection region for the first image which is repeatedly used.

4. The inspection apparatus according to claim 1, wherein the first image which is repeatedly used is combined with all of the pages of a print job configured with one or a plurality of pages.

5. The inspection apparatus according to claim 1,
wherein the storage unit stores information about the inspection region for the first image which is repeatedly used while associating the information with a specific identifier, and
wherein, upon receiving a specific identifier, the inspection unit inspects a printed product in which the third image has been printed, based on the inspection region set by the setting unit and the inspection region for the first image associated with the specific identifier stored in the storage unit.

6. The inspection apparatus according to claim 1,
wherein the inspection apparatus is configured to connect to an information processing apparatus in such a way as to be able to communicate with the information processing apparatus,
wherein the information processing apparatus includes a composition processing unit configured to combine the first image and the second image with each other, and
wherein, upon receiving the first image and an instruction for composition processing from a user, the information processing apparatus causes the composition processing unit to combine the first image and the second image with each other to generate the third image.

7. The inspection apparatus according to claim 1, wherein the first image which is repeatedly used is a master data image.

8. The inspection apparatus according to claim 1,
wherein the inspection apparatus is configured to connect to a printing apparatus in such a way as to be able to communicate with the printing apparatus, and
wherein the printing apparatus includes at least the image forming unit and the reading unit.

9. A control method for an inspection apparatus, the control method comprising:
receiving a read image acquired by reading, with a reading unit, each of printed products which are sequentially conveyed and received from an image forming unit;
setting an inspection region targeted for an inspection of each of the printed products based on the read image and a preliminarily registered reference image;
inspecting each of the printed products by performing inspection processing on the set inspection region based on the read image and the reference image; and
storing information about the inspection region for a first image which is repeatedly used,
wherein the inspecting includes inspecting a printed product in which a third image obtained by combining the first image and a second image with each other has been printed, based on the set inspection region and the inspection region for the first image the information about which has been stored.

10. An inspection system including at least an information processing apparatus and an inspection apparatus,
wherein the information processing apparatus comprises:
a composition processing unit configured to, upon receiving, from a user, an instruction for composition processing for a first image which is repeatedly used between pages and a second image, combine the first image and the second image with each other to generate a third image; and
a transmission unit configured to transmit the third image generated by the composition processing unit together with an identifier corresponding to the first image to the inspection apparatus,
wherein the inspection apparatus comprises:
a reception unit configured to receive a read image acquired by reading, with a reading unit, each of printed products which are sequentially conveyed and received from an image forming unit;
an inspection unit configured to inspect each of the printed products based on the read image and a preliminarily registered reference image;
a setting unit configured to set an inspection region targeted for an inspection to be performed by the inspection unit; and
a storage unit configured to store information about the inspection region for a first image which is repeatedly used, and
wherein, upon receiving the third image together with the identifier, the inspection unit inspects a printed product in which the third image has been printed, based on the inspection region set by the setting unit and the inspection region for the first image corresponding to the identifier the information about which has been stored in the storage unit.

11. The inspection system according to claim 10,
wherein the inspection apparatus further comprises a display control unit configured to display a screen on a display unit,
wherein the setting unit performs setting of the inspection region on the reference image displayed on the display unit by the display control unit, and
wherein, upon receiving the third image together with the identifier, the display control unit displays an inspection region based on the information stored in the storage unit on an image equivalent to the first image included in the third image displayed on the display unit.

12. The inspection system according to claim 10, wherein, in the information processing apparatus, upon receiving an instruction for combining a first image which is repeatedly used between pages with a print job configured with one or a plurality of pages, the composition processing unit combines the first image with each page of the print job.
